(19) United States
(12) Patent Application Publication
(10) Pub. No.: US 2024/0202872 A1
(43) Pub. Date: Jun. 20, 2024

(54) METHOD, APPARATUS, AND COMPUTER PROGRAM PRODUCT FOR IMAGE COMPRESSION

(71) Applicant: HERE GLOBAL B.V., Eindhoven (NL)

(72) Inventors: Chandra Sekhar PATI, Antarvedi (IN); Atiquer Rehman Abdul Matin SAYYED, Faridabad (IN); Ashish Maneklal PANCHAL, Mumbai (IN)

(21) Appl. No.: 18/067,430

(22) Filed: Dec. 16, 2022

(51) Int. Cl. G06T 3/40; G06T 7/10; G06T 9/00

(52) U.S. Cl. CPC G06T 3/4084; G06T 7/10; G06T 9/00; G06T 2207/20021; G06T 2207/20052

(57) ABSTRACT

A method is provided for image compression and compressed image reconstruction. Methods may include: receiving an original image from an image sensor, the image corresponding to a geographical location; dividing the original image into subdivisions of the original image where the subdivisions of the original image are a predefined pixel width by a predefined pixel height; applying a transformation to each subdivision of the original image; establishing a low-frequency component for each subdivision; and storing the low-frequency component as a value for each subdivision of the original image as a compressed image file. Methods may include identifying, within the original image, image information of relatively higher importance than a majority of the original image; and storing the image information of relatively higher importance than the majority of the original image with the compressed image file.

### TECHNOLOGICAL FIELD

An example embodiment of the present disclosure relates to image compression, and more particularly, for image compression and compressed image reconstruction.

### BACKGROUND

Digital imagery is an area of substantial, continued development since images can have wide applications across many platforms. The gathering of image data is used to train machine learning models, build databases, and for feature extraction for map data. The size of image files increases substantially with higher resolution images. Further, the continued development of ever-higher resolution cameras results in copious amounts of image data with file sizes increasing at an alarming rate relative to data storage capacities and communication bandwidth. The sheer volume of digital image files collected from various sources, together with the increasing resolution has led to storage capacity issues and bandwidth transmission issues.

Digital images are often compressed using a conventional image compression technique, such as using the JPEG (Joint Photographic Experts Group) standard or PNG (Portable Network Graphics) standard to reduce storage requirements and bandwidth transmission needs. However, these compression techniques can result in image quality degradation.

### BRIEF SUMMARY

A method, apparatus, and computer program product are provided in accordance with an example embodiment for the compression of digital images, and more particularly, for the compression of digital images and compressed image reconstruction. Embodiments provided herein include an apparatus having at least one processor and at least one memory including computer program code with the at least one memory and computer program code being configured to, with the processor, cause the apparatus to: receive an original image from an image sensor, the image corresponding to a geographical location; divide the image into subdivisions of the original image, where the subdivisions of the original image are a predefined pixel width by a predefined pixel height; apply a transformation to the subdivisions of the original image; establish a low-frequency component for the subdivisions; and store the low-frequency component as a value for the subdivisions of the original image as a compressed image file.

According to certain embodiments, the apparatus is further caused to: identify, within the original image, image information of relatively higher importance than a majority of the original image; and store the image information of a relatively higher importance than the majority of the original image with the compressed image file. Causing the apparatus to identify, within the original image, the image information of relatively higher importance than a majority of the original image includes, in some embodiments, causing the apparatus to: identify one or more bounding boxes within the original image, the image information of relatively higher importance than the majority of the original image being contained within the one or more bounding boxes. Causing the apparatus of some embodiments to apply the transformation to the subdivisions of the original image include causing the apparatus to selectively apply a Discrete Cosine Transformation to each subdivision of the original image not including the image information of relatively higher importance than a majority of the original image to convert values of each subdivision to a frequency domain.

According to certain embodiments, the predefined pixel width is eight pixels and the predefined pixel height is eight pixels, where the subdivisions of the original image are eight-by-eight pixel blocks. According to some embodiments, causing the apparatus to apply the transformation to each subdivision of the original image includes causing the apparatus to apply a Discrete Cosine Transformation to the subdivisions of the original image to convert values of the subdivisions to a frequency domain. According to certain embodiments, the compressed image file includes a Portable Graphics Format image file. A value for each pixel of the Portable Graphics Format image file includes, in some embodiments, a value corresponding to the low-frequency component for a corresponding subdivision of the original image.

The apparatus of an example embodiment is further caused to retrieve the compressed image file; expand the compressed image file; apply an inverse transformation to each subdivision of the expanded, compressed image file to form a generated image; and process the generated image using a machine learning model to generate a reconstructed image substantially equivalent to the original image. Causing the apparatus to expand the compressed image file includes, in some embodiments, causing the apparatus to: assign the value for each subdivision of the original image as an index value of a pixel of a corresponding expanded subdivision; and assign values of zero to remaining pixels other than the pixel having the index value corresponding expanded subdivision. The original image from the image sensor is, in some embodiments, captured along a road of a first functional class at the geographical location, where the machine learning model is trained using image data from a geographic region within a predetermined degree of similarity to the geographical location and captured along segments of the first functional class.

Embodiments provided herein include a method including: receiving an original image from an image sensor, the image corresponding to a geographical location; dividing the image into subdivisions of the original image where the subdivisions of the original image are a predefined pixel width by a predefined pixel height; applying a transformation to the subdivisions of the original image; establishing a low-frequency component for the subdivisions; and storing the low-frequency component as a value for the subdivisions of the original image as a compressed image file. Dividing the image into subdivisions of the original image includes, in some embodiments, dividing the original image into 8-by-8 pixel blocks.

The method of some embodiments further includes: identifying, within the original image, image information of relatively higher importance than a majority of the original image; and storing the image information of relatively higher importance than the majority of the original image with the compressed image file. According to some embodiments, identifying, within the original image, the image information of relatively higher importance than the majority of the original image includes: identifying one or more bounding boxes within the original image, the image information of relatively higher importance than the majority of the original image being contained within the one or more bounding boxes. According to some embodiments, applying the transformation to the subdivisions of the original image includes selectively applying a Discrete Cosine Transform to each subdivision of the original image not including the image information of relatively higher importance than the majority of the original image to convert values of each subdivision to a frequency domain.

According to some embodiments, applying the transformation to the subdivisions of the original image includes applying a Discrete Cosine Transformation to the subdivisions of the original image to convert values of each subdivision to a frequency domain. A value for each pixel of the compressed image file includes, in some embodiments, a value corresponding to the low-frequency component for a corresponding subdivision of the original image. The method of some embodiments includes: retrieving the compressed image file; expanding the compressed image file; applying an inverse transformation to each subdivision of the expanded, compressed image to form a generated image; and processing the generated image using a machine learning model to generate a reconstructed image substantially equivalent to the original image. According to some embodiments, expanding the compressed image file includes: assigning the value for each subdivision of the original image as an index value of a pixel of a corresponding expanded subdivision; and assigning values of zero to remaining pixels other than the pixel having the index value of the corresponding expanded subdivision. The original image from the image sensor is, in some embodiments, captured along a road of a first functional class at the geographical location, where the machine learning model is trained using image data from a geographic region within a predetermined degree of similarity to the geographical location and captured along road segments of the first functional class.

Embodiments provided herein include a computer program product including at least one non-transitory computer-readable storage medium having computer-executable program code instructions stored therein, the computer-executable program code instructions including program code instructions to: receive an original image from an image sensor, the image corresponding to a geographical location; divide the image into subdivisions of the original image, where the subdivisions of the original image are a predefined pixel width by a predefined pixel height; apply a transformation to the subdivisions of the original image; establish a low-frequency component for the subdivisions; and store the low-frequency component as a value for each subdivision of the original image as a compressed image file. Embodiments described herein further include a computer program product having computer-executable program code portions stored therein, the computer executable program code portions including program code instructions configured to perform any method described herein.

According to certain embodiments, the computer program product further includes program code instructions to: identify, within the original image, image information of relatively higher importance than a majority of the original image; and store the image information of a relatively higher importance than the majority of the original image with the compressed image file. The program code instructions to identify, within the original image, the image information of relatively higher importance than a majority of the original image includes, in some embodiments, program code instructions to: identify one or more bounding boxes within the original image, the image information of relatively higher importance than the majority of the original image being contained within the one or more bounding boxes. The program code instructions of some embodiments to apply the transformation to the subdivisions of the original image include program code instructions to selectively apply a Discrete Cosine Transformation to each subdivision of the original image not including the image information of relatively higher importance than a majority of the original image to convert values of each subdivision to a frequency domain.

According to certain embodiments, the predefined pixel width is eight pixels and the predefined pixel height is eight pixels, where the subdivisions of the original image are eight-by-eight pixel blocks. According to some embodiments, the program code instructions to apply the transformation to each subdivision of the original image includes program code instructions to apply a Discrete Cosine Transformation to the subdivisions of the original image to convert values of the subdivisions to a frequency domain. According to certain embodiments, the compressed image file includes a Portable Graphics Format image file. A value for each pixel of the Portable Graphics Format image file includes, in some embodiments, a value corresponding to the low-frequency component for a corresponding subdivision of the original image.

The computer program product of an example embodiment further includes program code instructions to retrieve the compressed image file; expand the compressed image file; apply an inverse transformation to each subdivision of the expanded, compressed image file to form a generated image; and process the generated image using a machine learning model to generate a reconstructed image substantially equivalent to the original image. The program code instructions to expand the compressed image file includes, in some embodiments, program code instructions to: assign the value for each subdivision of the original image as an index value of a pixel of a corresponding expanded subdivision; and assign values of zero to remaining pixels other than the pixel having the index value corresponding expanded subdivision. The original image from the image sensor is, in some embodiments, captured along a road of a first functional class at the geographical location, where the machine learning model is trained using image data from a geographic region within a predetermined degree of similarity to the geographical location and captured along segments of the first functional class.

Embodiments provided herein include an apparatus including: means for receiving an original image from an image sensor, the image corresponding to a geographical location; means for dividing the image into subdivisions of the original image where the subdivisions of the original image are a predefined pixel width by a predefined pixel height; means for applying a transformation to the subdivisions of the original image; means for establishing a low-frequency component for the subdivisions; and means for storing the low-frequency component as a value for the subdivisions of the original image as a compressed image file. The means for dividing the image into subdivisions of the original image includes, in some embodiments, means for dividing the original image into 8-by-8 pixel blocks.

The apparatus of some embodiments further includes: means for identifying, within the original image, image information of relatively higher importance than a majority of the original image; and means for storing the image information of relatively higher importance than the majority of the original image with the compressed image file. According to some embodiments, the means for identifying, within the original image, the image information of relatively higher importance than the majority of the original image includes: means for identifying one or more bounding boxes within the original image, the image information of relatively higher importance than the majority of the original image being contained within the one or more bounding boxes. According to some embodiments, the means for applying the transformation to the subdivisions of the original image includes means for selectively applying a Discrete Cosine Transform to each subdivision of the original image not including the image information of relatively higher importance than the majority of the original image to convert values of each subdivision to a frequency domain.

According to some embodiments, the means for applying the transformation to the subdivisions of the original image includes means for applying a Discrete Cosine Transformation to the subdivisions of the original image to convert values of each subdivision to a frequency domain. A value for each pixel of the compressed image file includes, in some embodiments, a value corresponding to the low-frequency component for a corresponding subdivision of the original image. The apparatus of some embodiments includes: means for retrieving the compressed image file; means for expanding the compressed image file; means for applying an inverse transformation to each subdivision of the expanded, compressed image to form a generated image; and means for processing the generated image using a machine learning model to generate a reconstructed image substantially equivalent to the original image. According to some embodiments, the means for expanding the compressed image file includes: means for assigning the value for each subdivision of the original image as an index value of a pixel of a corresponding expanded subdivision; and means for assigning values of zero to remaining pixels other than the pixel having the index value of the corresponding expanded subdivision. The original image from the image sensor is, in some embodiments, captured along a road of a first functional class at the geographical location, where the machine learning model is trained using image data from a geographic region within a predetermined degree of similarity to the geographical location and captured along road segments of the first functional class.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a communication diagram of a system for implementing example embodiments described herein according to an example embodiment of the present disclosure;

FIG. 2 is a block diagram of an apparatus for image compression and compressed image reconstruction according to an example embodiment of the present disclosure;

FIG. 3 illustrates a flowchart of a method for an image compression and decompression/reconstruction process according to an example embodiment of the present disclosure;

FIG. 4 illustrates the decompression from low-frequency image to the reconstructed image that is substantially similar to the original image according to an example embodiment of the present disclosure; and

FIG. 5 illustrates a flowchart of a process for image compression according to an example embodiment of the present disclosure.

### DETAILED DESCRIPTION

Example embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

A system, method, apparatus, and computer program product are provided herein in accordance with an example embodiment for image compression, and more particularly, for image compression and compressed image reconstruction. This compression and reconstruction can be performed quickly, such as even in real-time or near real-time. Real-time or substantially real-time, as described herein, is used to describe a response occurring immediately, or within seconds or fractions of a second.

Image data has long been a source of storage and memory concerns, as image data has increased in both volume and size of individual images. Image capture devices, such as digital cameras, have evolved from capturing images of one megapixel or a fraction thereof, to now capturing images in the hundreds of megapixels. The vast increase in image resolution has led to a corresponding increase in the amount of memory each captured image requires. Further, the ubiquity of digital cameras and image sensors has increased the volume of image files captured. The increase in volume of images and the increase in the size of images has led to an issue with respect to storage. Digital images are often compressed using a conventional image compression technique, such as using the JPEG (Joint Photographic Experts Group) standard or PNG (Portable Network Graphics) standard. These compression techniques can result in image quality degradation. Embodiments described herein provide a high compression ratio while resolving quality issues that often arise from image compression. Embodiments employ image and signal processing to generate a compressed image with low frequency components that can save a substantial portion of storage (e.g., more than 50%), where the low frequency components cannot be seen clearly with the human eye.

Embodiments described herein use a restoration process employing a deep learning Generative Adversarial Network model that can use compressed images and generate an image very similar to the original image. The deep learning model of embodiments is trained for a given region and functional classes within that region to adapt the model for the surroundings in order to better reproduce the approximation of the original image within a high degree of similarity.

There exist use cases where images need to be retrieved from memory in real-time with substantially the same quality as when the original image from when the image was captured. These use cases, in general, are unpredictable and random in nature, and there is no specific time range for which the image needs to be retrieved. This renders image archiving in low-cost memory storage systems very difficult as the image needs to be retrieved in real-time. To mitigate storage and retrieval costs, embodiments store only key details from an image which can reduce over half of the storage cost (e.g., around 66% of storage cost). When an image for a given region is retrieved, the key details of the stored image can be used as input to a deep learning model along with the given region and the model can create an image substantially similar to the original image.

One example scenario in which images are captured at high resolution in high volumes is in the field of autonomous or semi-autonomous vehicles. Fully-autonomous vehicles are capable of operation without a human driver, while semi-autonomous vehicles may rely on a human driver for certain functionality. Vehicles with some degree of autonomy generally employ image sensors to capture images of their environment to understand the roadway and the environment of the roadway. Further, these images can be used for localization of the vehicle and to build high-definition maps that can be used for localization even if the vehicle is being driven in entirely manual mode at the time. For instance, a vehicle traveling along a road segment may capture an image and compare the captured image with a stored image that includes location information from a very-close location. Through comparison of those images, a vehicle may have a better understanding of their position. As is evident, retrieval of such images from storage can be sporadic and unpredictable, such that image reconstruction as described herein is highly desirable to minimize a storage footprint of images while providing access to the images in substantially real-time to aid in localization and to facilitate autonomous or semi-autonomous vehicle control.

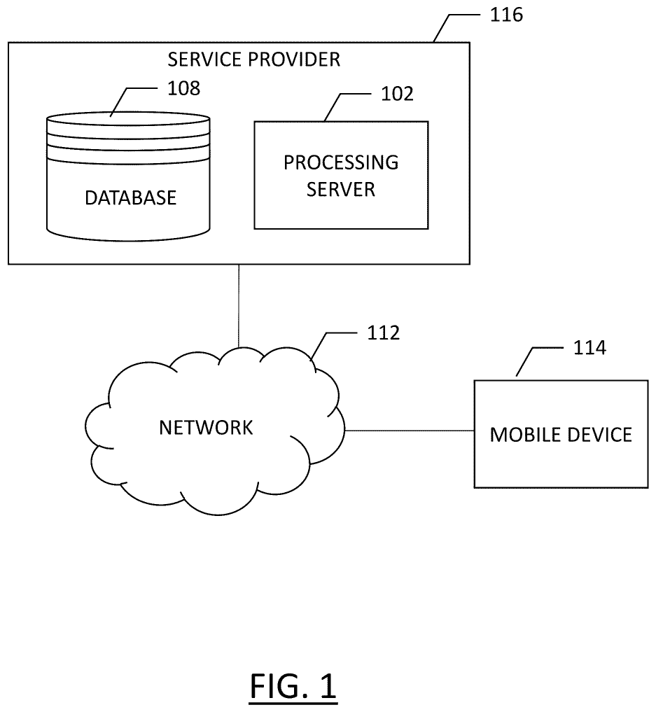

FIG. 1 illustrates a communication diagram of an example embodiment of a system for implementing example embodiments described herein. The illustrated embodiment of FIG. 1 includes a service provider 116, a processing server 102 in data communication with a database 108 (e.g., a map database, an image database, etc.) through a network 112, and one or more mobile devices 114. The mobile device 114 may be associated, coupled, or otherwise integrated with a vehicle, such as an advanced driver assistance system (ADAS), for example. Optionally, the mobile device 114 can be a mobile computing device, such as a mobile phone, tablet computer, etc. Additional, different, or fewer components may be provided. For example, many mobile devices 114 may connect with the network 112. The service provider 116 may include computer systems and a network of a system operator. The network may be wired, wireless, or any combination of wired and wireless communication networks, such as cellular, Wi-Fi, internet, local area networks, or the like.

The database 108, when embodied as a map database, can include map data for high-definition (HD) maps. The map data of such an embodiment may include node data, road segment data or link data, point of interest (POI) data, or the like. The database 108 embodied by a map database may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the database 108 embodied by a map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The database 108 can include data about the POIs and their respective locations in the POI records. The database 108 embodied as a map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the database 108 can include event data (e.g., traffic incidents, construction activities, scheduled events, unscheduled events, etc.) associated with the POI data records or other records of the database 108.

The database 108 may be maintained by a content provider in association with a services platform. For example, the service provider 116 can be a map service provider, and the database 108 can be a map database that includes images such as in an HD map, or an image database that is used by service providers to retrieve image data for use in various use cases. By way of example, the service provider 116 embodied by a map service provider can collect geographic data to generate and enhance the database 108. There can be different ways used by the service provider 116 to collect data. These ways can include obtaining data from other sources, such as municipalities or respective geographic authorities. In addition, the service provider can employ field personnel to travel by vehicle along roads throughout a geographic region to observe features and/or record information about them, such as capturing images of the environment within a geographic region, for example. Additional data sources can include OEM vehicles that may provide camera images, camera detections, radar information, LiDAR information, ultrasound information, and/or other sensing technologies. Also, probe data histogram images, aerial imagery, LiDAR data, and dash camera images among others can be used to generate map geometries directly or to facilitate localization within a mapped region. The database 108 may include the digital map data for a geographic region or for an entire mapped space, such as for one or more countries, one or more continents, etc. The database 108 may partition the mapped space using spatial partitions to segment the space into map tiles that are more manageable than the entire mapped space.

According to an example embodiment described herein, the database 108 is employed to store localized machine learning models that correspond to different geographical constructs for image reconstruction purposes. The geographical constructs can include a type of geographical area, such as inhabited plains, forests, rural, industrial, urban, residential business, mixed-use, etc. The geographical constructs can include a type of region, such as states, cities, counties, countries, or continents. The geographical constructs can optionally include functional road classes, such as transportation department standards, third-party standards, or the like, including freeways, major arterial roads, minor arterial roads, major collector roads, minor collector roads, local roads, and termination/parking roads. The geographical constructs can be any combination of these features, and may optionally include temporal factors, such as season, time-of-year, weather, traffic, etc. Image data may change based on these different factors.

The database 108, when embodied as a map database, may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems including in conjunction with autonomous and semi-autonomous navigation systems. Such a master map database can include stored image data associated with a geographic area, such as images map-matched to locations along road segments to facilitate localization and change detection in real-world environments.

For example, geographic data may be compiled (such as into a platform specification format (PSF)) to organize and/or configure the data for performing navigation-related functions and/or services, such as route calculation, route guidance, map display, speed calculation, distance and travel time functions, and other functions, by a navigation device, such as by mobile device 114, for example. The navigation-related functions can correspond to vehicle navigation, pedestrian navigation, or other types of navigation. The compilation to produce the end user databases can be performed by a party or entity separate from the map services provider. For example, a customer of the map services provider, such as a navigation services provider or other end user device developer, can perform compilation on a received map database in a delivery format to produce one or more compiled navigation databases.

As mentioned above, the database 108 may be a master geographic database, but in alternate embodiments, a client side map database may represent a compiled navigation database that may be used in or with end user devices (e.g., mobile device 114) to provide navigation and/or map-related functions. For example, the database 108 may be used with the mobile device 114 to provide an end user with navigation features, such as through image extraction and comparison. In such a case, the database 108 can be downloaded or stored on the end user device (mobile device 114) which can access the database 108 through a wireless or wired connection, such as via a processing server 102 and/or the network 112, for example.

In certain embodiments, the end user device or mobile device 114 can be an in-vehicle navigation system, such as an ADAS, a personal navigation device (PND), a portable navigation device, a cellular telephone, a smart phone, a personal digital assistant (PDA), a watch, a camera, a computer, and/or other device that can perform navigation-related functions, such as digital routing and map display. End user devices may optionally include automated computer systems, such as map data service provider systems and platforms as the map may be processed, utilized, or visualized via one or more other computing systems. An end user can use the mobile device 114 for navigation and map functions such as guidance and map display, for example, and for determination of one or more personalized routes or route segments based on one or more calculated and recorded routes, according to some example embodiments.

While the mobile device 114 may be used by an end-user for navigation, driver assistance, or various other features, the mobile device 114 may provide map data and image data to the service provider 116 for purposes of updating, building, restoring, or repairing the database 108, for example. The processing server 102 may receive probe data from a mobile device 114. The mobile device 114 may include one or more detectors or sensors as a positioning system built or embedded into or within the interior of the mobile device 114. Alternatively, the mobile device 114 uses communications signals for position determination. The mobile device 114 may receive location data from a positioning system, such as a global positioning system (GPS), cellular tower location methods, access point communication fingerprinting, or the like. The processing server 102 may receive sensor data configured to describe a position of a mobile device, or a controller of the mobile device 114 may receive the sensor data from the positioning system of the mobile device 114. The mobile device 114 may also include a system for tracking mobile device movement, such as rotation, velocity, or acceleration. Movement information may also be determined using the positioning system. The mobile device 114 may use the detectors and sensors to provide data indicating a location of a vehicle. This vehicle data, also referred to herein as “probe data”, may be collected by any device capable of determining the necessary information, and providing the necessary information to a remote entity. The mobile device 114 is one example of a device that can function as a probe to collect probe data of a vehicle.

The mobile device 114 of an example embodiment can include an Advanced Driver Assistance System (ADAS). An ADAS may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Some advanced driver assistance systems may employ digital map data. Such systems may be referred to as map-enhanced ADAS. The digital map data can be used in advanced driver assistance systems to provide information about the road network, road geometry, road conditions, and other information associated with the road and environment around the vehicle. Unlike some sensors, the digital map data is not affected by the environmental conditions such as fog, rain, or snow. Additionally, the digital map data can provide useful information that cannot reliably be provided by sensors, such as curvature, grade, bank, speed limits that are not indicated by signage, lane restrictions, and so on. Further, digital map data can provide a predictive capability well beyond the driver's vision to determine the road ahead of the vehicle, around corners, over hills, or beyond obstructions. Accordingly, the digital map data can be a useful and sometimes necessary addition for some advanced driving assistance systems. In the example embodiment of a fully-autonomous vehicle, the ADAS uses the digital map data to determine a path along the road network to drive, such that accurate representations of the road are necessary, such as accurate representations of intersections and turn paths there through. Thus, it is important to have continuous features remain continuous within the map data as provided by embodiments herein.

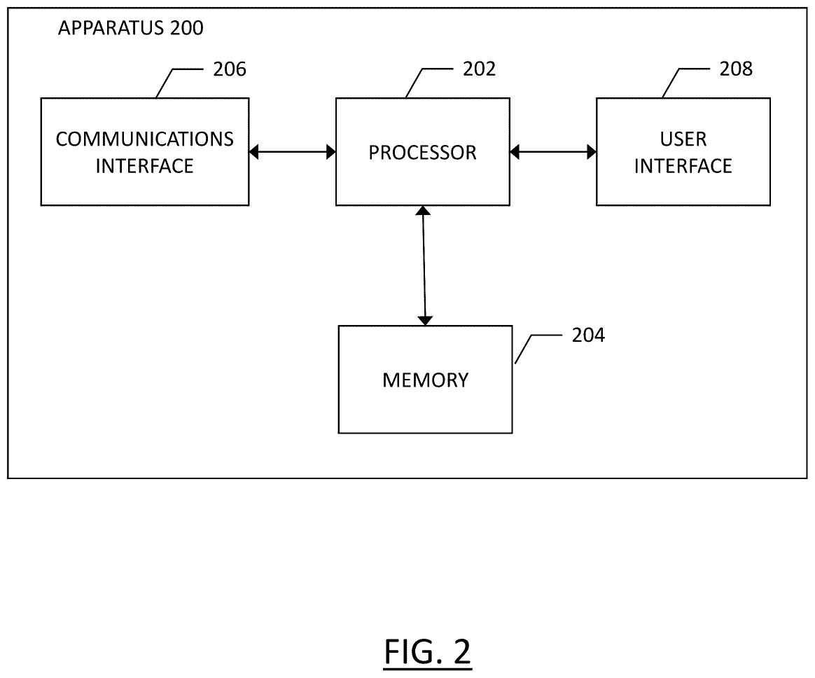

An example embodiment of a processing server 102 may be embodied in an apparatus 200 as illustrated in FIG. 2. The apparatus, such as that shown in FIG. 2, may be specifically configured in accordance with an example embodiment of the present disclosure for image compression and compressed image reconstruction. The apparatus may include or otherwise be in communication with a processor 202, a memory 204, a communication interface 206, and a user interface 208. In some embodiments, the processor (and/or co-processors or any other processing circuitry assisting or otherwise associated with the processor) may be in communication with the memory via a bus for passing information among components of the apparatus. The memory may be non-transitory and may include, for example, one or more volatile and/or non-volatile memories. In other words, for example, the memory may be an electronic storage device (for example, a computer readable storage medium) comprising gates configured to store data (for example, bits) that may be retrievable by a machine (for example, a computing device like the processor 202). The memory may be configured to store information, data, content, applications, instructions, or the like, for enabling the apparatus to carry out various functions in accordance with an example embodiment of the present disclosure. For example, the memory could be configured to buffer input data for processing by the processor. Additionally or alternatively, the memory could be configured to store instructions for execution by the processor.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. Embodiments described herein can further employ a processer embodied by a Graphics Processing Unit (GPU) specifically configured for neural network implementations and/or image processing capitalizing on efficient processing capabilities using multiple parallel operations. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor specific device (for example, a mobile terminal or a fixed computing device) configured to employ an embodiment of the present disclosure by further configuration of the processor by instructions for performing the algorithms and/or operations described herein. The processor may include, among other things, a clock, an arithmetic logic unit (ALU) and logic gates configured to support operation of the processor.

The apparatus 200 of an example embodiment may also include a communication interface 206 that may be any means such as a device or circuitry embodied in either hardware or a combination of hardware and software that is configured to receive and/or transmit data to/from a communications device in communication with the apparatus, such as to facilitate communications with one or more mobile devices 114 or the like. In this regard, the communication interface may include, for example, an antenna (or multiple antennae) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 200 may also include a user interface 208 that may, in turn be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory 204, and/or the like).

The apparatus 200 of FIG. 2 can optionally embody the mobile device 114. According to such an embodiment, the apparatus 200 can further include sensor(s), such as an image sensor or image capture device to capture images that are subsequently compressed. Further, the mobile device 114 itself can, in some embodiments, perform the compressed image reconstruction using processor 202.

Image compression and reconstruction is a very valuable process to improve the efficiency with which systems operate, including the service provider 116 and the mobile device 114. Given the ever-increasing size of images in terms of pixels and the increasing volume of these images, image compression and reconstruction continues to be a field of development to mitigate the storage requirements of image data and the bandwidth required to transmit or communicate image data between systems, such as between the service provider 116 and mobile device 114.

Storing high quality images (e.g., relatively high pixel count images) consumes large amounts of storage, even with available image compression means such as JPEG and the like. Lossless compression techniques have limited capabilities in terms of compression ratio, such that as image sizes increase, the benefit of compression does not commensurately increase in efficiency. Embodiments described herein stores only the low frequency components of an image leading to a substantial compression of over fifty-percent, and can average a compression ratio of about two-thirds. Using a deep learning, machine learning model, an image that is substantially the same as the original image can be recovered with the low frequency components when needed in near real-time. As only the low-frequency components of the image are stored, only minute changes can be observed between the original image and the reconstructed image. This approach compresses the original image by about two-thirds and provides the ability to fetch and decompress a reconstructed image in near real-time with the reconstructed image having a structural similarity index above 99% of the original image.

According to an example embodiment described herein, images are captured by an image capture device associated with a vehicle as it travels along a road within a geographic area. Images captured by vehicles traveling along road segments are good candidates for embodiments of the described image compression and restoration process due to contextual similarities in such images. Certain features are likely to be present in most images captured as a vehicle travels along a road segment. The images collected can be collected from a forward-facing image sensor, but also captured as “cube images” which are images captured from panoramic cameras which may include a 360-degree view of an environment of the vehicle. The collection of images is performed for specific geographic regions and for specific road functional classes. The images from the geographic region are used to train the machine learning model, leading to generation of models based on a geographic region and respective functional class of roadways within the geographic region.

The images used to train the machine learning model do not necessarily have to be from the same geographic region where images are captured for processing by the machine learning model as the training data could be from a similar geographic area. For example, geographic areas that have similar topography and/or similar road features (e.g., sign formats, lane lines, etc.) can be substantially equivalent for purposes of the machine learning model training data. The similarity between a geographic location where an image is collected relative to a geographic region from which a machine learning model is trained may be measured based on the similarity of the geographic constructs as described above. A machine learning model may be used if the geographic location at which an image is captured is within a predefined similarity of the geographic region on which the machine learning model was trained. This predefined similarity may be any combination of the geographic constructs described above to establish a model that is sufficiently accurate to reconstruct compressed images.

Using geographic-region specific machine learning models provides better context for images captured within the geographic region. Generally, geographic regions will have many similarities among the environments of the roads of different functional classes. Thus, the machine learning models are able to more accurately be used for reconstruction of images captured within the geographic region.

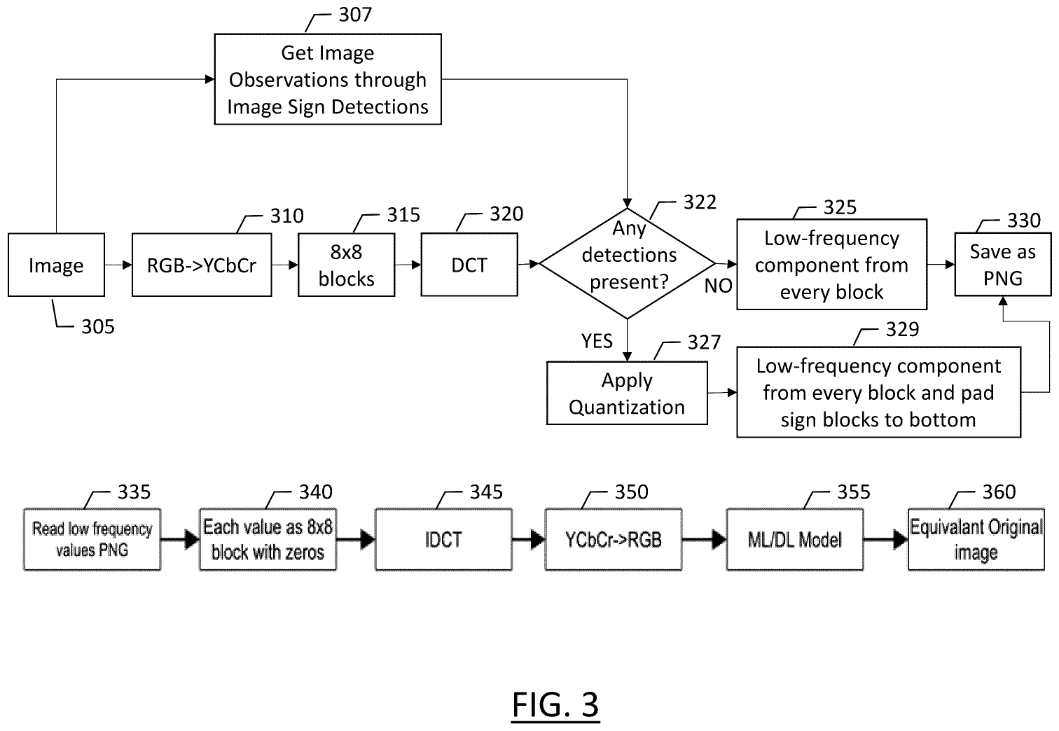

FIG. 3 illustrates a flowchart of a method for an image compression and decompression/reconstruction process. As shown, the captured image is received at 305. From the image, observations are determined through image sign detections at 307. This is where signs or other important information is detected within the image. Information within the image that is deemed more important than a majority of the image is flagged to avoid loss of the important information during compression and reconstruction. The image may be captured, for example, by an image sensor of a vehicle traveling along a road segment having a functional class within a geographic region. The image is scaled at 310 from red, green, and blue values (RGB) to luminance (Y) and chrominance (Cb and Cr) values of a YCbCr image. This process can separate luminance from chrominance more effectively than in the RGB color space. At 315, for the compression purpose and operating on pixel values, the image is subdivided into 8×8 pixel blocks. Following operations are performed on the 8×8 blocks, with the number of 8×8 blocks dependent upon the original image size.

At 320, a Discrete Cosine Transformation (DCT) is applied to each 8×8 block to convert the values to the frequency domain. The DCT application establishes the most visually significant information about the image, concentrated in only a few coefficients of the DCT. A determination is made at 322 if any areas of important information (e.g., signs) are present. If important information is detected, quantization is applied at 327. The low frequency component from every block (e.g., the 8×8 blocks) is established and the important information blocks (e.g., sign blocks) are padded to the bottom at 329 to ensure the important information is not lost. The compressed image can then be stored at 330 as a PNG (Portable Network Graphic) image. If there are no signs or other important information detections present at 322, the low-frequency component from every block is used at 325 without supplemental information, and stored as a PNG file at 330. The PNG image will thus contain the values of original images divided by 8×8 as only one value is stored for each 8×8 block. The image compression operations of 305-330 of FIG. 3 result in a compression of about two-thirds, tripling the efficiency of storage of the compressed image files.

Image reconstruction is also illustrated in FIG. 3 beginning at 335 where the low frequency values for the PNG image compressed through the above-described process are read. Each value of the PNG image representing 8×8 blocks are made to be the starting index, with the other 63 values of the 8×8 block as zeros at 340. This begins the reconstruction by scaling up the PNG image to an image of the same size as the original image. At 345, the Inverse Discrete Cosine Transformation (IDCT) is applied on each 8×8 block to obtain a YCbCr image. The YCbCr image is scaled from the luminance and chrominance space to the RGB space at 350. The RGB image has most of the features of the original image, but includes some distortions present due to loss of information. The RGB image is input to a pre-trained deep learning machine learning model at 355 that can generate the high-quality reconstructed image that is substantially equivalent to the original image at 360. Substantially equivalent reflects a measure where the reconstructed image is at least 95% the same as the original image, and in some cases, substantially equivalent reflects a measure where the reconstructed image is at least 99% the same as the original image.

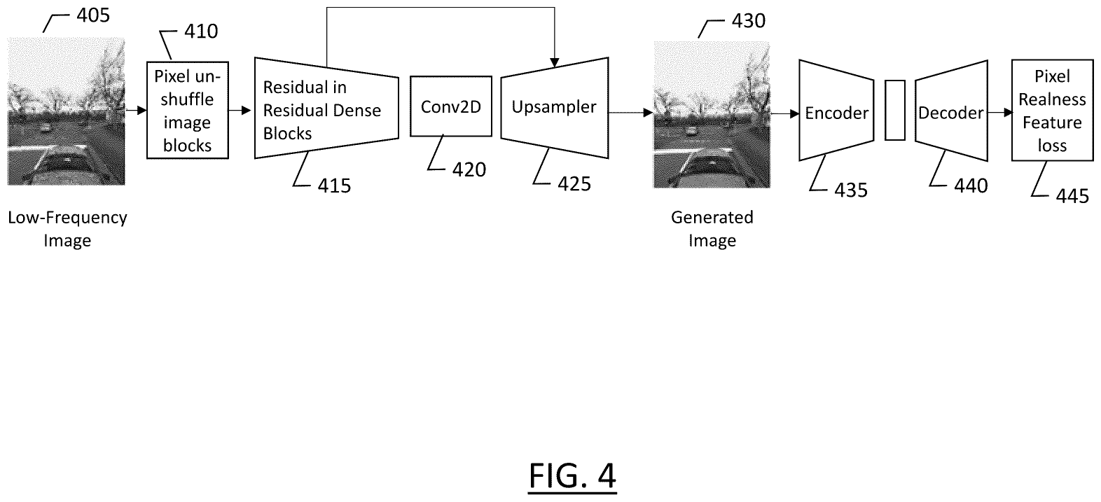

FIG. 4 illustrates the decompression from low-frequency image to the reconstructed image that is substantially similar to the original image. The stored, low-frequency image at 405 is expanded from the PNG format using each value representing an 8×8 block to image blocks at 410. At 415 the value representing the 8×8 block is made to be the starting index of the 8×8 block, with the remaining values being zero. This may be artificially achieved by zero-padding the remaining values. The IDCT is applied with a two-dimensional convolutional layer at 420, and upsampled at 425 from the YCbCr space to obtain the generated RGB image at 430. The RGB generated image is input to the encoder 435 of the machine learning model, and the decoder 440, to generate the pixel realness feature loss 445 for the reconstructed image.

Machine learning models benefit from large amounts of training data, which in embodiments described herein include high quality images and cube images from vehicles and mobile devices traveling along road segments within a road network of a geographic area. As a preprocessing step, the training data images are compressed to low-frequency images as described above. These low-frequency images are input to the deep learning model. The deep learning model of an example embodiment employs a Generative Adversarial Neural (GAN) Network to restore the quality of the image. The input image size is the same size as the original image, which means substantial resources are used while applying convolutional operations. To avoid requiring substantial processing resources, unshuffled pixel blocks can be used as input to the deep learning model. This lessens the input size while increasing the channels of the input, which results in no loss of information from the input image.

The deep learning model generator is primarily designed with Residual in Residual Dense blocks which produce reliable results based on machine learning and artificial intelligence research. The discriminator of example embodiments is designed also as a generator to generate reality of each pixel instead of the entire image. While training the deep learning model, the model learns prediction by the LI, perceptual, and discriminator loss values. The LI loss function is used to minimize the error which is the sum of all of the absolute differences between the true value and the predicted value. The perceptual loss function compares high level differences by summing all the squared errors between the pixels of the true value and predicted value, and taking the mean value. The discriminator loss function seeks to maximize the probability assigned to the true image and the predicted image.

Embodiments described herein thus provide a mechanism through which images are compressed with great efficiency, but are then able to be reconstructed using a machine learning model to obtain a reconstructed image that is substantially similar to the original image.

One of the issues in restoring imagery with trained networks, as opposed to an algorithmic decompression approach, is that details that are not distinguishable in the low-frequency version of the image may be restored with fantastic realism. However, this restoration process includes estimations made by a Generative Adversarial Network (GAN), and include a risk of restoring critical portions of an image incorrectly. These estimates can have significant impact on the meaning of an image. For example, in the context of images of an environment of a road as used in map data, artificial restorations for a sign, such as a speed limit sign, can have a significant impact for the interpretation of the reconstructed image. Depending upon the training data of the GAN and the low-frequency image, some instances may occur in which a posted speed limit sign of 25 miles-per-hour (mph) is stored as a low-frequency image, but is restored by the GAN to a 35 mph sign in the image. However, embodiments described herein provide a mechanism for addressing such occurrences.

Embodiments described herein employ a frequency range or defined frequency cut-off up to which image details, such as speed limit signs are encoded. These frequency ranges or frequency cut-off values can be established through machine learning, focusing on significant image details such as road signs. Restored images can be validated to confirm that such significant image details have been well preserved. Embodiments preserve features through adding extra details to the low-frequency image to improve the accuracy of the output image when reconstructed.

Certain features of an image can be more important than others, particularly in the context of image capture along a road segment by a vehicle. Signs found along a road segment within an image can provide important and meaningful information for safe navigation along the road segment. Signs including speed limit signs, stop signs, passing/no-passing zone signs, directional signs, etc. It is often critical that the content of the signs is accurate in a reconstructed image so as to not lose the meaning of the sign which can be detrimental to travel along the road segment. Signs and other features that impact navigation along a road segment can be identified as important areas of an image. Required information of important areas can be stored, such as through bounding boxes within the image of signs. These bounding boxes can be informed, for example, through ground truth observations. If an image includes a bounding box of important information, the image data can add the respective bounding box intersected slices quantized run length encoded components as padding to the low-frequency images with their respective slice (x,y) coordinates.

Having preserved the important information pertaining to the bounding boxes, with information is added into the low-frequency components of the image before inputting the image to the machine learning model, which will have clear information regarding the important details of the image. Having these details in the input image can pose issues for a machine learning model while generating an output image. To resolve these issues, the machine learning model described herein is fine-tuned with preserving detail images.

This process of preserving important information enables identification of critical areas of the image that need to be reconstructed accurately and repeatably to facilitate safe navigation along a road segment. As noted above, preserving sign information is often important for safe navigation. Images that are compressed without regard for such important information can lose critical elements of the image. Embodiments provided herein compress images with important information such that image reconstruction preserves the important information. As such, embodiments described herein are of significant benefit for vehicle travel, such as autonomous and semi-autonomous vehicle control.

Embodiments described herein are ideally suited to street-level imagery (SLI) archiving. This SLI archiving allows for storing of environmental imagery at different points in time, providing insight into the transformation or change of a region, serving as verification of a map and different road attributes (e.g., road surface, lane count, intersections, posted road signs, etc.) that were valid at the time of image capture. An archive would use an input of time (e.g., a date) and location to find the images captured at the location and restore these at that time using the process described herein.

A further use case of the aforementioned image compression and image reconstruction in substantially near real-time is provided herein for autonomous or semi-autonomous vehicle control. As a vehicle traverses a road segment, image data is gathered to inform a vehicle controller of a localized position of the vehicle relative to the environment and a geographic position. Images can be used to discern the environment of the vehicle, and facilitate autonomous or sei-autonomous control through an understanding of the environment of the vehicle.

As images are collected by vehicles traveling along a road segment, the images can be gathered, compressed, and stored as described above. However, the gathered images can further be used for comparison to images stored, for example, in database 108 of a service provider 116. A vehicle traveling along a road segment can request images of the environment from a map service provider to use for localization and guidance. Those images can be requested based on location of the vehicle, for example. A map service provider can retrieve the images and provide the images to the vehicle for use in localization and guidance. Optionally, the low-frequency images can be reconstructed by the map services provider, or the low-frequency images can be reconstructed at the mobile device or vehicle. If the mobile device 114 embodied by the vehicle has sufficient capacity to operate the machine learning model, communication bandwidth can be reduced by providing the low-frequency images to the mobile device for reconstruction. However, if the mobile device does not have an appropriate machine learning model (e.g., one associated with the geographic area in which the mobile device is located), the reconstruction may be performed by the service provider, and the reconstructed images provided to the mobile device.

The machine learning models of example embodiments can include geographic area specific models that are associated with specific geographic areas and/or areas having specific geographical constructs as described above. The use of geographic area specific models can be employed to improve effectiveness of the models, as environments, signage, and road construction features are likely to be similar to one another within the geographic area. Having an understanding of the geographical constructs of a region can enable a machine learning model to be applied to image data that is captured from a different region, provided the region of the machine learning model is within a predefined degree of similarity of the different region. For example, the machine learning models can optionally be road functional classification specific. Road functional classifications within a geographic area (e.g., within a country, or within a state) are likely to share many features and to have similar visual cues. Thus, machine learning models that are trained using images of a specific road functional class within a specific geographic area have a greater likelihood of high accuracy due to similarities between the training data and the inputs to the machine learning model. Thus, the outputs of the machine learning model are likely to be considerably more accurate.

FIGS. 3 through 5 illustrate flowcharts depicting methods according to example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of an apparatus employing an embodiment of the present disclosure and executed by a processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems that perform the specified functions, or combinations of special purpose hardware and computer instructions.

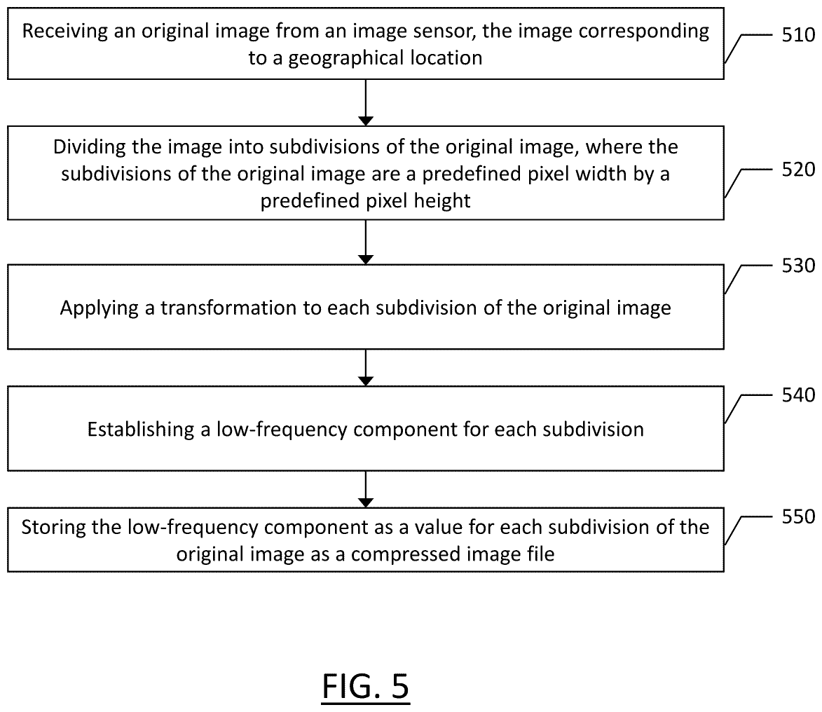

An operation of an example apparatus will herein be described with reference to the flow chart of FIG. 5. The illustrated method may be performed, for example, by apparatus 200 using processor 202 with program code instructions stored in memory 204 to cause the apparatus to perform the operations of the method of FIG. 5. As shown, the apparatus is caused to receive an original image from an image sensor at 510, where the image corresponds to a geographical location. This image sensor can be embodied as a sensor of an autonomous or semi-autonomous vehicle, or an image sensor of a mobile device traveling within an environment. Important information, such as signs, can be detected within the image. This can be performed, for example, by a machine learning model or other image detection techniques. The important information can be identified using a bounding box to specify the area of the image where loss of content could be detrimental. The image is divided at 520 into subdivisions of the original image, where the subdivisions are a predefined pixel width and a predefined pixel height. These subdivisions are, for example, 8-by-8 pixels in some embodiments to enable piece-wise manipulation. A transformation is applied to each subdivision of the original image at 530. This transformation may be, for example, a Discrete Cosine Transformation. A low-frequency component can be established for each subdivision at 540. The low-frequency component is stored as a value for each subdivision of the original image as a compressed file at 550. If important information is detected in the image, that information can also be stored with the low-frequency components in the compressed image file to ensure no unreasonable loss of fidelity within the important areas.

Embodiments of the process described herein with respect to the flowcharts of any of FIGS. 3 through 5 are specifically configured to improve the functioning of a computer itself. By virtue of establishing a new and reliable technique for image compression that is able to compress images down by two thirds, the required memory capacity is greatly reduced. Further, the reconstruction of the compressed images, as described herein, not only produces images that are substantially the same as the original image, but can do so relatively quickly given the compression benefit achieved. This process improves the functioning of a computer itself through requiring less memory and requiring lower communication bandwidth, as the compressed image files can be transmitted for reconstruction through the machine learning model at a remote device.

In an example embodiment, an apparatus for performing the methods of FIGS. 3 through 5 above may include a processor (e.g., the processor 202) configured to perform some or each of the operations (305-360, 405-445, and/or 510-550) described above. The processor may, for example, be configured to perform the operations (305-360, 405-445, and/or 510-550) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 305-360, 405-445, and/or 510-550 may comprise, for example, the processor 202 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and computer program code configured to, with the processor, cause the apparatus to at least:
receive an original image from an image sensor, the image corresponding to a geographical location;
divide the original image into subdivisions of the original image, wherein the subdivisions of the original image are a predefined pixel width by a predefined pixel height;
apply a transformation to the subdivisions of the original image;
establish a low-frequency component for the subdivisions; and
store the low-frequency component as a value for the subdivisions of the original image as a compressed image file.

2. The apparatus of claim 1, wherein the apparatus is further caused to:
identify, within the original image, image information of relatively higher importance than a majority of the original image; and
store the image information of relatively higher importance than the majority of the original image with the compressed image file.

3. The apparatus of claim 2, wherein causing the apparatus to identify, within the original image, the image information of relatively higher importance than the majority of the original image comprises causing the apparatus to:
identify one or more bounding boxes within the original image, the image information of relatively higher importance than the majority of the original image being contained within the one or more bounding boxes.

4. The apparatus of claim 2, wherein causing the apparatus to apply the transformation to the subdivisions of the original image comprises causing the apparatus to selectively apply a Discrete Cosine Transformation to each subdivision of the original image not including the image information of relatively higher importance than a majority of the original image to convert values of each subdivision to a frequency domain.

5. The apparatus of claim 1, wherein the predefined pixel width is eight pixels and the predefined pixel height is eight pixels, wherein the subdivisions of the original image are eight-by-eight pixel blocks.

6. The apparatus of claim 5, wherein causing the apparatus to apply the transformation to the subdivisions of the original image comprises causing the apparatus to apply a Discrete Cosine Transformation to the subdivisions of the original image to convert values of each subdivision to a frequency domain.

7. The apparatus of claim 1, wherein the compressed image file comprises a Portable Graphics Format image file, wherein a value for each pixel of the Portable Graphics Format image file comprises a value corresponding to the low-frequency component for a corresponding subdivision of the original image.

8. The apparatus of claim 1, wherein the apparatus is further caused to:
retrieve the compressed image file;
expand the compressed image file;
apply an inverse transformation to each subdivision of the expanded, compressed image to form a generated image; and
process the generated image using a machine learning model to generate a reconstructed image substantially equivalent to the original image.

9. The apparatus of claim 8, wherein causing the apparatus to expand the compressed image file comprises causing the apparatus to:
assign the value for each subdivision of the original image as an index value of a pixel of a corresponding expanded subdivision; and
assign values of zero to remaining pixels other than the pixel having the index value of the corresponding expanded subdivision.

10. The apparatus of claim 8, wherein the original image from the image sensor is captured along a road of a first functional class at the geographical location, wherein the machine learning model is trained using image data from a geographic region within a predetermined degree of similarity to the geographical location and captured along road segments of the first functional class.

11. A method comprising:
receiving an original image from an image sensor, the image corresponding to a geographical location;
dividing the original image into subdivisions of the original image, wherein the subdivisions of the original image are a predefined pixel width by a predefined pixel height;
applying a transformation to the subdivisions of the original image;
establishing a low-frequency component for the subdivisions; and
storing the low-frequency component as a value for the subdivisions of the original image as a compressed image file.

12. The method of claim 11, further comprising:
identifying, within the original image, image information of relatively higher importance than a majority of the original image; and
storing the image information of relatively higher importance than the majority of the original image with the compressed image file.

13. The method of claim 12, wherein identifying, within the original image, the image information of relatively higher importance than the majority of the original image comprises:
identifying one or more bounding boxes within the original image, the image information of relatively higher importance than the majority of the original image being contained within the one or more bounding boxes.

14. The method of claim 12, wherein applying the transformation to the subdivisions of the original image comprises selectively applying a Discrete Cosine Transformation to each subdivision of the original image not including the image information of relatively higher importance than a majority of the original image to convert values of each subdivision to a frequency domain.

15. The method of claim 11, wherein the predefined pixel width is eight pixels, and the predefined pixel height is eight pixels, wherein the subdivisions of the original image are eight-by-eight pixel blocks.

16. The method of claim 15, wherein applying the transformation to the subdivisions of the original image comprises applying a Discrete Cosine Transformation to the subdivisions of the original image to convert values of each subdivision to a frequency domain.

17. The method of claim 11, further comprising:
retrieving the compressed image file;
expanding the compressed image file;
applying an inverse transformation to each subdivision of the expanded, compressed image to form a generated image; and
processing the generated image using a machine learning model to generate a reconstructed image substantially equivalent to the original image.

18. The method of claim 17, wherein expanding the compressed image file comprises:
assigning the value for each subdivision of the original image as an index value of a pixel of a corresponding expanded subdivision; and
assigning values of zero to remaining pixels other than the pixel having the index value of the corresponding expanded subdivision.

19. The method of claim 17, wherein the original image from the image sensor is captured along a road of a first functional class at the geographical location, wherein the machine learning model is trained using image data from a geographic region within a predetermined degree of similarity to the geographical location and captured along road segments of the first functional class.

20. A computer program product comprising at least one non-transitory computer-readable storage medium having computer-executable program code instructions stored therein, the computer-executable program code instructions comprising program code instructions to:
receive an original image from an image sensor, the image corresponding to a geographical location;
divide the original image into subdivisions of the original image, wherein the subdivisions of the original image are a predefined pixel width by a predefined pixel height;
apply a transformation to the subdivisions of the original image;
establish a low-frequency component for the subdivisions; and
store the low-frequency component as a value for the subdivisions of the original image as a compressed image file.
